(19) United States
(12) Patent Application Publication
(10) Pub. No.: US 2026/0220630 A1
(43) Pub. Date: Jul. 30, 2026

(54) SYSTEMS AND METHODS FOR IMMUTABLY RECORDING AND VERIFYING CRYPTOGRAPHIC FILE HASHES USING BLOCKCHAIN-BASED NON-FUNGIBLE TOKENS

(71) Applicant: Tate T Uecker, Newberg, OR (US)

(72) Inventor: Tate T Uecker, Newberg, OR (US)

(21) Appl. No.: 19/440,699

(22) Filed: Jan. 6, 2026

Related U.S. Application Data
(60) Provisional application No. 63/751,034, filed on Jan. 29, 2025.

(51) Int. Cl. G06Q 20/38; G06Q 20/36; H04L 9/00

(52) U.S. Cl. CPC G06Q 20/389; G06Q 20/363; H04L 9/50

(57) ABSTRACT

Systems and methods are disclosed for immutably recording cryptographic file hash values on-chain and verifying candidate digital files. Bytes of a digital file are hashed to generate a cryptographic file hash value, which is submitted to a smart contract deployed to a blockchain network and stored in on-chain storage. The smart contract creates a transferable on-chain ownership representation associated with the stored cryptographic file hash value, wherein the ownership representation comprises a non-fungible token in one embodiment and a transferable registry record in another embodiment. For verification, a candidate digital file is hashed to generate a candidate cryptographic file hash value, which is compared to the stored cryptographic file hash value to output a validity result.

### CROSS-REFERENCE TO RELATED APPLICATIONS

This application claims the benefit of U.S. Provisional Ser. No. 63/751,034, filed Jan. 29, 2025, the entire disclosure of which is incorporated herein by reference.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### BACKGROUND OF THE INVENTION

### Field of the Invention

The present disclosure relates to cryptographic hashing and blockchain-based systems, and more particularly to immutably recording cryptographic file hash values derived from bytes of a digital file in on-chain storage and enabling verification and transfer of associated rights using smart contracts.

### Description of Related Art

Digital files (e.g., documents, images, audio, video, and software) are easily copied, modified, and redistributed. In many contexts, parties require an objective mechanism to demonstrate that a specific digital file existed at a given time, and that a later-presented file is identical to an earlier file.

Centralized registries can be altered, may be subject to outages, and generally require trust in an administrator. Blockchain networks can provide a tamper-resistant ledger; however, existing approaches often (i) store only mutable pointers to off-chain content without deterministically binding the on-chain record to the bytes of a particular file, (ii) record arbitrary values not derived from bytes of a digital file, or (iii) omit a transferable on-chain representation of ownership or control associated with a recorded cryptographic file hash. There remains a need for mechanisms that focus on cryptographic file hashes (rather than arbitrary hashes), store such file hashes on-chain, and support verification and controlled transfer of rights associated with the recorded file hash.

### BRIEF SUMMARY OF THE INVENTION

In one or more embodiments, a cryptographic file hash value is computed by applying a cryptographic hash function to the bytes of a digital file (or to a canonicalized byte representation of the file). The cryptographic file hash value is submitted to a smart contract deployed to a blockchain network and stored in on-chain storage to provide an immutable record of the file's cryptographic fingerprint.

The smart contract creates an on-chain ownership representation associated with the stored cryptographic file hash value. In one embodiment, the ownership representation comprises a non-fungible token (NFT) whose token identifier is bound to the stored cryptographic file hash value. In another embodiment, the ownership representation comprises a transferable registry record stored in the smart contract (e.g., a mapping from a record identifier to the file hash and an owner wallet address), without minting a token. Transfer of the ownership representation updates on-chain ownership state and enables provenance tracking.

For verification, a candidate digital file is hashed using the same hash algorithm to generate a candidate cryptographic file hash value, which is compared against the stored cryptographic file hash value to determine whether the candidate file matches the originally recorded file. Optional embodiments include permissioned verification, batch recording using Merkle commitments, multi-chain deployments, and privacy-enhanced techniques such as encryption, commitments, and zero-knowledge proofs.

### BRIEF DESCRIPTION OF THE DRAWINGS

FIG. 1 is a functional block diagram illustrating an example process for recording a cryptographic file hash value on a blockchain network and creating a transferable on-chain ownership representation associated with the stored cryptographic file hash value.

FIG. 2 is a functional block diagram illustrating an example process for verifying a candidate digital file by comparing a candidate cryptographic file hash value to a cryptographic file hash value stored on-chain.

### DETAILED DESCRIPTION OF THE INVENTION

### Definitions

As used herein:
“Digital file” refers to an electronic file comprising bytes, including documents, images, audio, video, software binaries, structured data objects, or serialized records.
“Cryptographic file hash” or “cryptographic file hash value” refers to an output of a cryptographic hash function applied to bytes of a digital file (or a canonicalized byte representation thereof), such that a change in the file bytes is expected to produce a different hash output.
“Blockchain network” refers to a distributed ledger network (public, permissioned, or private), including layer-2 networks or sidechains.
“Smart contract” refers to program code deployed to a blockchain network that maintains on-chain state and executes deterministically in response to transactions.
“On-chain ownership representation” refers to an on-chain record associated with a stored cryptographic file hash value that indicates a current owner wallet address and supports transfer of ownership between wallet addresses. The ownership representation may be implemented as a non-fungible token, as a registry record (e.g., a mapping entry), or as a successor, variant, extension, or functional equivalent of such mechanisms.

### System Overview

In one embodiment, a client device or server receives a digital file and computes a cryptographic file hash value from the bytes of the digital file. A transaction is submitted to a blockchain network to invoke a smart contract, which stores the cryptographic file hash value in on-chain storage and creates an on-chain ownership representation associated with the stored cryptographic file hash value.

In an NFT embodiment, the smart contract mints a non-fungible token and binds a token identifier to the stored cryptographic file hash value. In a registry-only embodiment, the smart contract creates a registry record and stores the file hash and ownership information in a mapping keyed by a record identifier, without minting a token.

The digital file itself need not be stored on-chain. Instead, the on-chain record stores the cryptographic file hash value (and optionally an algorithm identifier, timestamp, and/or metadata pointer), enabling later verification of file integrity and provenance while avoiding disclosure of file contents.

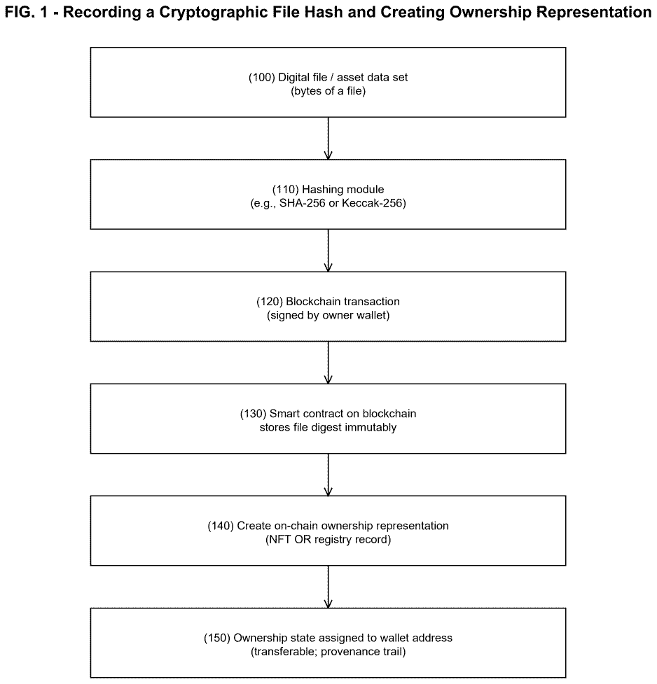

### Example Method for Recording a Cryptographic File Hash Value (FIG. 1)

In one embodiment, a method includes:
(a) receiving a digital file comprising bytes;
(b) generating a cryptographic file hash value by applying a cryptographic hash function to the bytes of the digital file;
(c) submitting, to a blockchain network, a transaction invoking a smart contract and including the cryptographic file hash value;
(d) storing, by the smart contract, the cryptographic file hash value in immutable on-chain storage; and
(e) creating, by the smart contract, an on-chain ownership representation associated with the stored cryptographic file hash value and associating the ownership representation with an owner wallet address.

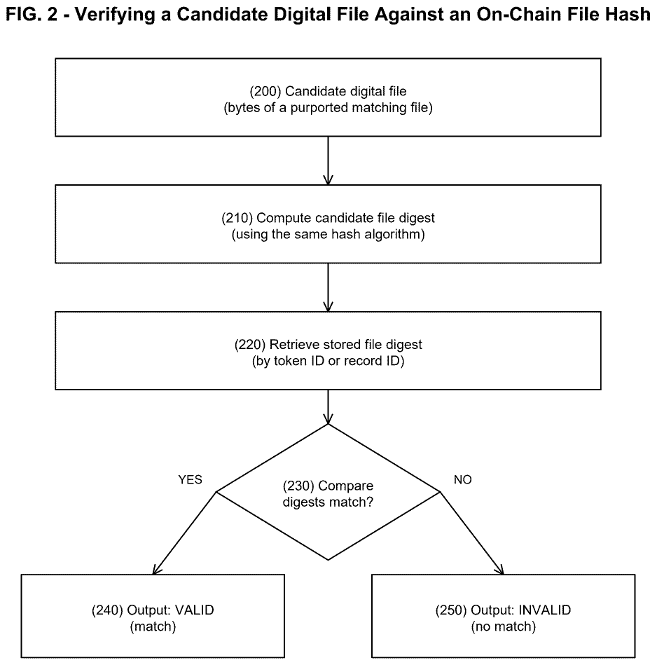

### Example Method for Verifying a Candidate Digital File (FIG. 2)

In one embodiment, a method includes:
(a) receiving a candidate digital file comprising bytes;
(b) generating a candidate cryptographic file hash value using the same cryptographic

hash function;
(c) retrieving a stored cryptographic file hash value associated with a token identifier and/or a record identifier;
(d) comparing the candidate cryptographic file hash value to the stored cryptographic file hash value; and
(e) outputting a result indicative of whether the candidate digital file matches the originally recorded digital file.

### Optional Embodiments

Optional embodiments may include one or more of the following, alone or in combination:
Batch recording of multiple cryptographic file hash values in a single transaction.
Permissioned verification in which a verification function is restricted to an owner address, an allowlisted verifier, or an address holding an access right.
Merkle-tree commitments to store an on-chain root while enabling inclusion proofs for individual file hashes.
Multi-chain deployment and synchronization of records and/or ownership state across multiple blockchain networks.
Privacy-enhanced techniques such as storing encrypted off-chain content and recording on-chain pointers, commitments, and/or proofs.

Example Smart-contract Pseudocode (enablement)

The following pseudocode illustrates example off-chain and on-chain logic. The pseudocode is illustrative and may be implemented in various languages and token standards (including successor, variant, extension, or functional equivalents) without departing from the disclosed principles.

OFF-CHAIN (CLIENT) PSEUDOCODEfunction recordFile(fileBytes, algoId, metaURI,
mode): digest = HASH(algoId, fileBytes) // cryptographic FILE
hash if mode ″NFT″: tx = Registry.mintTokenForDigest(digest, algoId,
metaURI) else: tx = Registry.registerDigest(digest, algoId, metaURI)
receipt = SEND_TRANSACTION(tx return receipt.recordIdOrTokenIdfunction
verifyFile(recordIdOrTokenId, fileBytes, algoId): candidate = HASH(algoId,
fileBytes) stored = Registry.getDigest(recordIdOrTokenId) return (candidate
== stored)
ON-CHAIN (SMART CONTRACT) PSEUDOCODE (REGISTRY-ONLY EMBODIMENT) contract
FileHashRegistry: struct Record: bytes32 digest uint8 algoId
uint64 createdAt address owner string metaURI uint256
nextRecordId mapping (uint256 => Record) recordById event
RecordCreated(uint256 recordId, bytes32 digest, address owner) event
RecordTransferred(uint256 recordId, address from, address to) function
registerDigest(bytes32 digest, uint8 algoId, string metaURI) returns (uint256
recordId): recordId = ++nextRecordId recordById [recordId] =
Record(digest, algoId, NOW( ), MSG_SENDER( ), metaURI) emit
RecordCreated(recordId, digest, MSG_SENDER( ) ) return recordId function
transferRecord (uint256 recordId, address to): require (MSG_SENDER( ) ==
recordById[recordId].owner) from = recordById [recordId].owner
recordById[recordId].owner = to emit RecordTransferred (recordId, from, to)
function getDigest(uint256 recordId) view returns (bytes32): return
recordById[recordId].digest function verify(uint256 recordId, bytes32
candidateDigest) view returns (bool): return (candidateDigest ==
recordById[recordId].digest)
ON-CHAIN (SMART CONTRACT) PSEUDOCODE (NFT EMBODIMENT, ERC-721-LIKE) contract
FileHashToken: struct Relic: bytes32 digest uint8 algoId
uint64 createdAt address creator string metaURI uint256
next TokenId mapping (uint256 => Relic) relicById function
mintTokenForDigest (bytes32 digest, uint8 algoId, string metaURI) returns (uint256
tokenId): tokenId = ++nextTokenId relicById[tokenId] = Relic (digest,
algoId, NOW( ), MSG_SENDER( ), metaURI) SAFE_MINT(MSG_SENDER( ), tokenId)
// token ownership is transferable return tokenId function
getDigest (uint256 tokenId) view returns (bytes32): return
relicById[tokenId].digest function verify (uint256 tokenId, bytes32
candidateDigest) view returns (bool): return (candidateDigest ==
relicById[tokenId].digest)

1. A computer-implemented method comprising: receiving a digital file comprising bytes;
generating a cryptographic file hash value by applying a cryptographic hash function to the bytes of the digital file; submitting the cryptographic file hash value to a smart contract deployed to a blockchain network; storing, by the smart contract, the cryptographic file hash value in on-chain storage; creating, by the smart contract, an on-chain ownership representation associated with the stored cryptographic file hash value; associating the on-chain ownership representation with a first blockchain wallet address; transferring ownership of the on-chain ownership representation from the first blockchain wallet address to a second blockchain wallet address by invoking one or more smart-contract functions; and recording, in on-chain storage, an updated owner state indicative of the second blockchain wallet address.

2. The method of claim 1, wherein the on-chain ownership representation comprises a non-fungible token minted in accordance with a token standard, interface, protocol, program, or contract pattern for representing unique tokenized assets on a blockchain network, including any successor, variant, extension, or functional equivalent thereof.

3. The method of claim 2, wherein the token standard is compatible with at least one of an ERC-721-compatible standard, an ERC-1155-compatible standard, a Solana SPL token program supporting non-fungible assets, a Tezos FA2 implementation supporting non-fungible assets, or an equivalent standard.

4. The method of claim 1, wherein the on-chain ownership representation comprises a registry record stored in the smart contract without minting a token, the registry record mapping a record identifier to at least the stored cryptographic file hash value and an owner wallet address.

5. The method of claim 1, wherein the smart contract stores, in association with the stored cryptographic file hash value, at least one of a timestamp, an identifier of the cryptographic hash function, or a metadata pointer to off-chain data.

6. The method of claim 1, further comprising verifying a candidate digital file by: generating a candidate cryptographic file hash value by applying the cryptographic hash function to bytes of the candidate digital file; retrieving the stored cryptographic file hash value associated with the on-chain ownership representation; comparing the candidate cryptographic file hash value to the stored cryptographic file hash value; and outputting a result indicative of whether the candidate digital file matches the digital file from which the stored cryptographic file hash value was generated.

7. The method of claim 1, wherein generating the cryptographic file hash value comprises applying at least one of SHA-256, SHA-3, Keccak-256, or BLAKE2 to the bytes of the digital file.

8. The method of claim 6, wherein verifying the candidate digital file is permissioned by requiring that a caller of a verification function is at least one of: an owner of the on-chain ownership representation, an allowlisted verifier address, or a holder of an on-chain access right.

9. The method of claim 1, further comprising batch recording a plurality of cryptographic file hash values corresponding to a plurality of digital files in a single blockchain transaction.

10. The method of claim 9, wherein batch recording comprises generating a Merkle tree over the plurality of cryptographic file hash values and storing a Merkle root on-chain as a commitment.

11. The method of claim 1, further comprising generating and verifying a zero-knowledge proof that a private digital file hashes to the stored cryptographic file hash value without revealing the private digital file.

12. The method of claim 1, wherein the blockchain network comprises at least one of a layer-1 network, a layer-2 network, or a sidechain.

13. The method of claim 1, further comprising synchronizing at least one of the stored cryptographic file hash value or ownership state across a plurality of blockchain networks using a bridge or messaging protocol.

14. The method of claim 1, wherein the digital file is not stored on-chain and only the cryptographic file hash value is stored on-chain.

15. The method of claim 1, wherein associating the on-chain ownership representation with the first blockchain wallet address comprises assigning ownership to a transaction sender address or to a designated recipient address supplied in the blockchain transaction.

16. A system comprising: one or more processors; and a memory storing instructions that, when executed by the one or more processors, cause the system to: generate a cryptographic file hash value from bytes of a digital file; submit a transaction to a smart contract deployed to a blockchain network, the transaction including the cryptographic file hash value; cause the smart contract to store the cryptographic file hash value in on-chain storage; cause the smart contract to create an on-chain ownership representation associated with the stored cryptographic file hash value; and cause the smart contract to maintain an on-chain owner state for the on-chain ownership representation that is transferable between blockchain wallet addresses.

17. The system of claim 16, wherein the on-chain ownership representation comprises a non-fungible token, and wherein transfer of the non-fungible token effects transfer of ownership of the on-chain ownership representation.

18. The system of claim 16, wherein the on-chain ownership representation comprises a registry record stored in a smart-contract mapping without minting a token, and wherein transfer of the registry record is performed by updating an owner field and emitting an on-chain transfer event.

19. A non-transitory computer-readable medium storing instructions that, when executed by one or more processors, cause the one or more processors to perform operations comprising: generating a cryptographic file hash value from bytes of a digital file; submitting the cryptographic file hash value to a smart contract deployed to a blockchain network; causing the smart contract to store the cryptographic file hash value in on-chain storage; causing the smart contract to create an on-chain ownership representation associated with the stored cryptographic file hash value; and transferring ownership of the on-chain ownership representation between blockchain wallet addresses by invoking one or more smart-contract functions that update on-chain owner state.

20. The non-transitory computer-readable medium of claim 19, wherein the instructions further cause the one or more processors to store, off-chain, an encrypted copy of at least a portion of the digital file and to store, on-chain, a metadata pointer or content address for retrieving the encrypted copy.
